(19) United States
(12) Patent Application Publication
(10) Pub. No.: US 2018/0117674 A1
(43) Pub. Date: May 3, 2018

(54) Eutectic Alloy Bonding for Foreign Parts or Items During the Additive Manufacturing Process

(71) Applicants: Nicholas Cavaliere, Toms River, NJ (US); Kamal Bhakta, Anaheim, CA (US); Ian Gallagher, Metuchen, NJ (US); Steven Orciuolo, JR., Point Pleasant, NJ (US); Denise Orthner, Hammonton, NJ (US)

(72) Inventors: Nicholas Cavaliere, Toms River, NJ (US); Kamal Bhakta, Anaheim, CA (US); Ian Gallagher, Metuchen, NJ (US); Steven Orciuolo, JR., Point Pleasant, NJ (US); Denise Orthner, Hammonton, NJ (US)

(73) Assignee: United States of America as represented by the Secretary of the Navy, Patuxent River, MD (US)

(21) Appl. No.: 15/335,780

(22) Filed: Oct. 27, 2016

(51) Int. Cl. B22F 3/10; B22F 3/105; B22F 3/24; B33Y 10/00; B33Y 40/00; B23K 1/00; B23K 35/26; C22C 11/06

(52) U.S. Cl. CPC B22F 3/1017; B22F 3/1055; B22F 3/24; B33Y 10/00; B22F 2998/10; B23K 1/0008; B23K 35/268; C22C 11/06; B22F 2003/248; B33Y 40/00

(57) ABSTRACT

A method for eutectic alloy bonding of foreign parts during the additive manufacturing process includes the following steps: designing a component for additive manufacturing printing which will include a foreign part such that the foreign part is bonded to the component via an eutectic alloy solder and disposed within a recess; starting to print the component using an additive manufacturing printer; stopping the additive manufacturing printer at the point where the foreign part and the eutectic alloy solder will be placed; placing the foreign part and solder into the recess; restarting the additive manufacturing printer such that the component is completed; and, heat treating the component such that the eutectic alloy solder forms a secure bond between the foreign part and the completed component.

### STATEMENT OF GOVERNMENT INTEREST

The invention described herein may be manufactured and used by or for the Government of the United States of America for governmental purposes without payment of any royalties thereon or therefor.

### BACKGROUND

Additive manufacturing (AM), also known as 3D printing or powder bed fusion printing, refers to the various processes used to synthesize a three-dimensional object from metallic powders. In additive manufacturing, successive layers of material are added or formed under computer control to create an object. A print head moves across the work surface depositing a very thin layer of powder which is then selectively fused to the layer below via an overhead power source, such as a laser, to form components layer-by-layer. The work surface retracts and the process repeats. Additive manufacturing printers are capable of printing novel geometries not possible via traditional methods of manufacturing.

Currently, there are several limitations to additive manufacturing. Most additive manufacturing printers can only print with one material at a time. Powder bed fusion printers cannot print overhangs, or objects directly supported from layers, and internal cavities are typically filled with powder. Integration of different alloys, foreign parts, items, or bodies cannot be printed into an additive manufacturing part where the alloy is required for desired material, mechanical, or electrical properties. In certain instances, a foreign part, item, or body needs to be placed within an item. This foreign part, item, or body may be, but without limitation, a sensor, an alloy, of any other type of foreign part, item, body, or material.

### SUMMARY

The present invention is directed to with the needs enumerated above and below.

The present invention is directed to a method for eutectic alloy bonding of foreign parts or items during the additive manufacturing process, which includes the following steps: designing a component for additive manufacturing which will include a foreign part such that the foreign part is bonded to the component via an eutectic alloy solder and disposed within a recess; starting to print the component using an additive manufacturing printer; stopping the additive manufacturing printer at a point where the foreign part and the eutectic alloy solder will be placed; placing the foreign part and solder into the recess; restarting the additive manufacturing printer such that the component is completed; and, heat treating the completed component such that the eutectic alloy solder forms a secure bond between the foreign part and the printed component. The foreign part is thus secured during the cooling phase of the heat treat process, permitting relief of internal stresses within the host component (during heat treat) without sacrificing structural integrity of the foreign part.

It is a feature of the present invention to provide a method for eutectic alloy bonding of foreign parts or items during the additive manufacturing process where a foreign part or item may be integrated into an additive manufactured component.

It is a feature of the present invention to provide a method for eutectic alloy bonding of foreign parts or items during the additive manufacturing process which allows integration of different materials within the additive manufactured component.

It is a feature of the present invention to provide a method for eutectic alloy bonding of foreign parts or items during the additive manufacturing process that secures foreign parts within a component manufactured using additive manufacturing.

it is a feature of the present invention to provide a method for eutectic alloy bonding of foreign parts or items during the additive manufacturing process that secures an embedded part or item within an additive manufactured component.

### DRAWINGS

These and other features, aspects and advantages of the present invention will become better understood with reference to the following description and appended claims, and accompanying drawings wherein:

FIG. 1 is a cross section of print where the print should be paused in order to install the eutectic alloy and the foreign part;

FIG. 2 is a cross section of a depiction of completed print with the installed foreign part and the eutectic alloy solder;

FIG. 3 is a perspective view of the ledge and groove geometry where the eutectic alloy solder and foreign part will be positioned; and,

FIG. 4 is a cross section of the depiction of the eutectic alloy solder placed in the groove and placement of the installed foreign part.

### DESCRIPTION

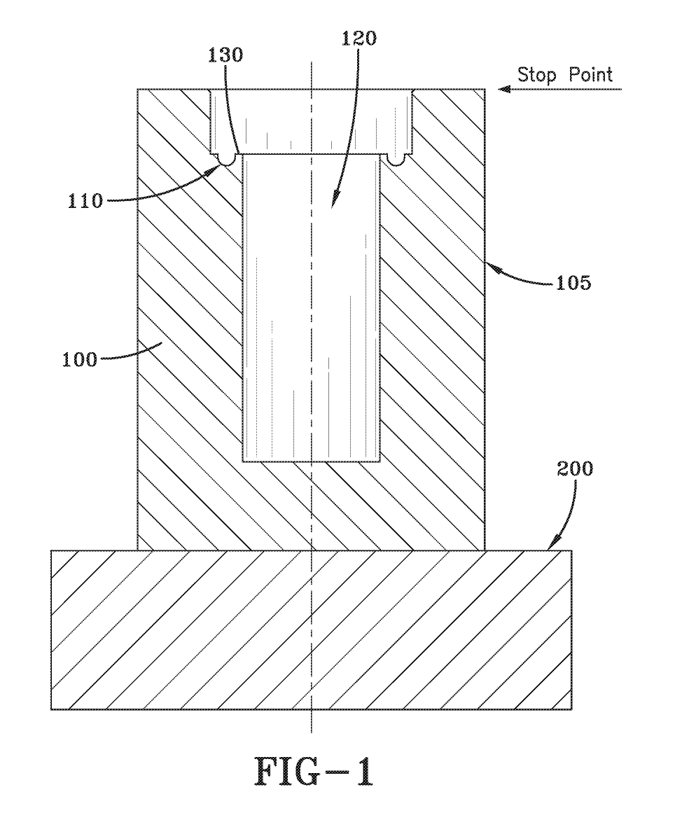

The preferred embodiments of the present invention are illustrated by way of example below and in FIGS. 1-4. The method for eutectic alloy bonding of foreign items, parts, or bodies during the additive manufacturing process includes the following steps: designing a component 100 (or work piece) for additive manufacturing printing which will include a foreign part 400 such that the foreign part 400 is bonded to the component 100 via an eutectic alloy solder 300 and disposed within a recess 115; starting to print the component 100 using an additive manufacturing printer; stopping the additive manufacturing printer at the point where the foreign part 400 and the eutectic alloy solder 300 will be placed; placing the foreign part 400 and eutectic alloy solder 300 into the recess 115; restarting the additive manufacturing printer such that the component 100 is completed; and, heat treating the component 100 such that the eutectic alloy solder 300 forms a secure bond between the foreign part 400 and the completed component 100.

In the description of the present invention, the invention will be discussed in a powder bed fusion printing environment; however, this invention can be utilized for any type of application that requires use of a bond in the additive manufacturing process.

The method described herein utilizes additive manufacturing in order to produce a final component 100. The preferred additive manufacturing printer is a Direction Metal Laser Sintering (DMSL) Printer; however, any additive manufacturing printer or the equivalent may be utilized.

The preferred component material (the additive manufacture material) used to print the component 100 and act as a substrate material is 4340 steel powder, though any material that is suitable for additive manufacturing can be used.

The preferred solder material is eutectic 63%/37% Pb-Sn. However, any alloy or solder material may be utilized, so long as the alloy is eutectic and has a melting temperature below the stress relief temperature of the substrate material or component material, and/or lower than the melting point of the substrate material or component material.

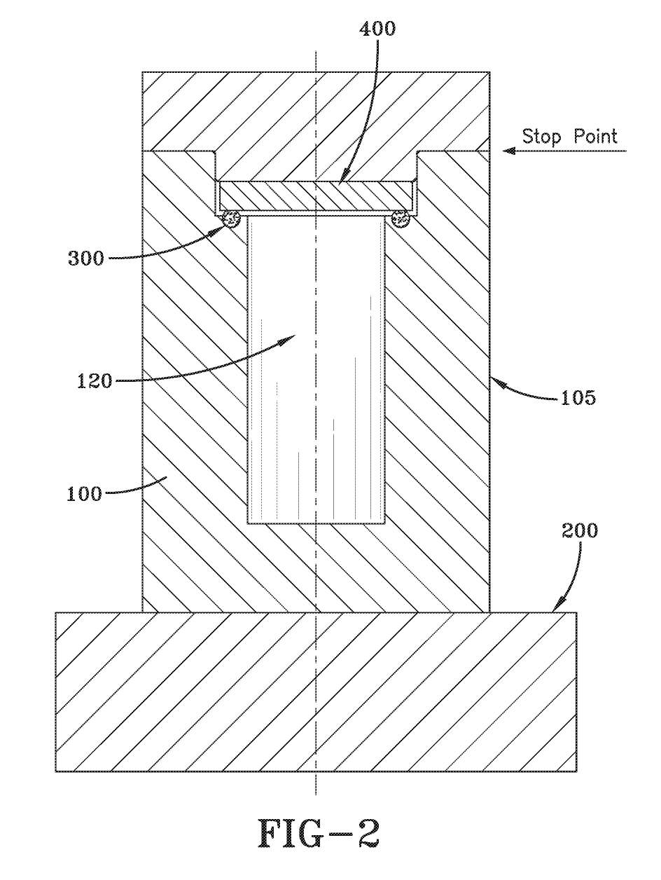

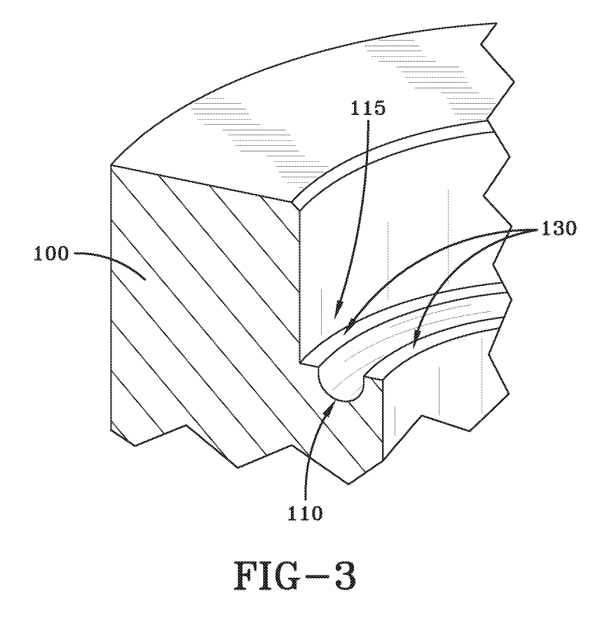

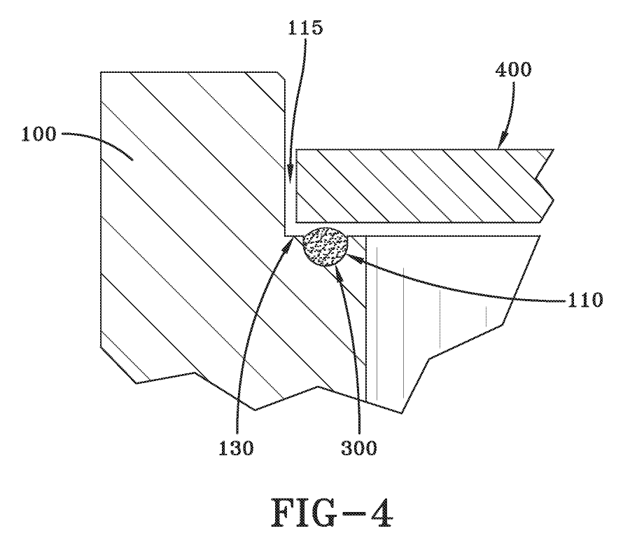

The foreign part 400 is installed in-situ during the additive manufacturing process. In operation, the additive manufacturing printer is stopped at the point where the foreign part 400 will be placed. FIG. 1 shows a cross section of where the printer will be stopped in order to install the eutectic alloy solder 300 and foreign part 400. In one of the embodiments, the work piece 100 (the component being printed by AM), positioned on a build plate 200, is made from additive manufacture material 105. As shown in FIG. 3, the work piece 100 includes a recess 115 that includes a groove 110 or trough for the eutectic alloy solder 300 and a ledge 130 to position the foreign part 400, and a cavity 120 disposed within the work piece 100. In the preferred embodiment, as shown in FIGS. 1-3, the ledge 130 is designed into the work piece 100 or component. The foreign part 400 is positioned and placed onto the ledge 130 when the printing is paused. The groove 110 may have the same radius as the eutectic alloy solder 300 used, so that the eutectic alloy solder 300 completely fills the groove 110 and fits snugly within. The foreign part 400 is then placed in the recess 115, specifically on the ledge 130, and then the printing process is restarted. As shown in FIGS. 2 and 4, the printing is continued until the work piece 100 is completed and the foreign part 400 is disposed within the work piece 100. In the preferred embodiment, as shown in FIGS. 3 and 4, there may be two ledges, each disposed on opposite sides of the groove 110.

In one of the preferred embodiments, the eutectic alloy solder 300 permits rigid bonding of the foreign part 400 during ambient conditions but is designed in such a way to melt in certain use conditions so as to act as a mechanical indicator of sorts. (e.g.: fuse/recalibration or repair of internal sensors/thermal switch). Additionally, the eutectic alloy solder 300 may be oriented in such a way as to solidify in a specific manner during the heat treat process (which may be different than the orientation during the additive manufacturing process) and remain solid during ambient conditions.

When introducing elements of the present invention or the preferred embodiment(s) thereof; the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A method for eutectic alloy bonding of a foreign part during an additive manufacturing process, the method comprising:
designing a component for additive manufacturing printing which will include a foreign part such that the foreign part is bonded to the component via an eutectic alloy solder and disposed within a recess;
starting to print the component using an additive manufacturing printer;
stopping the additive manufacturing printer at a point where the foreign part and the eutectic alloy solder will be placed;
placing the foreign part and the eutectic alloy solder into the recess;
restarting the additive manufacturing printer such that the component is completed; and,
heat treating the completed component such that the eutectic alloy solder forms a secure bond between the foreign part and the printed component.

2. The method of claim 2, wherein the additive manufacturing printer utilizes a component material with a stress relief temperature, and the eutectic alloy solder has a melting temperature below the stress relief temperature of the component material.

3. The method of claim 2, wherein the additive manufacturing printer utilizes a component material with a melting point, and the eutectic alloy solder has a melting temperature lower than the melting point of component material.

4. The method of claim 1, wherein the eutectic alloy solder permits rigid bonding of the foreign part during ambient conditions but is designed in such a way to melt in certain use conditions so as to act as a mechanical indicator of sorts.

5. The method of claim 1, wherein the eutectic alloy solder is oriented in such a way as to solidify in a specific manner during the heat treating and remain solid during ambient conditions.
